(19) United States
(12) Patent Application Publication
(10) Pub. No.: US 2017/0258108 A1
(43) Pub. Date: Sep. 14, 2017

(54) TREAT WITH FLAVORED STICK

(71) Applicant: Isabella Ryan English, Roswell, GA (US)

(72) Inventor: Isabella Ryan English, Roswell, GA (US)

(21) Appl. No.: 15/394,971

(22) Filed: Dec. 30, 2016

Related U.S. Application Data
(60) Provisional application No. 62/307,132, filed on Mar. 11, 2016.

(51) Int. Cl. A23G 9/50

(52) U.S. Cl. CPC A23G 9/503

(57) ABSTRACT

A food treat includes: a stick including a first portion, a second portion, and a coating; the first portion of the stick infused with the coating; and a food product attached to the first portion of the stick, the second portion of the stick configured to be held by a user. A coating system includes: a container; a flavoring solution held by the container; and a stick submerged in the flavoring solution, the flavoring solution including a flavoring oil.

### CROSS-REFERENCE TO RELATED APPLICATIONS

This application claims the benefit of U.S. Provisional Application No. 62/307,132 filed on Mar. 11, 2016, which is hereby specifically incorporated by reference herein in its entirety.

### TECHNICAL FIELD

Field of Use

This disclosure relates to food products placed on a stick. More specifically, this disclosure relates to food products placed on a flavored stick.

Related Art

Placing a stick at least partially inside a food product to make it possible to hold the food product during its consumption without directly touching the food product can provide several benefits to a person consuming the food product. With such a stick, one can avoid contaminating the food product with germs on the person's hands, one can avoid accelerated melting of a frozen food treat or accelerated cooling of a hot food treat (based on the person's body temperature or hand surface temperature being between the temperature of the frozen food treat and the hot food treat), and one can avoid the discomfort of directly touching a cold or warm food product. It is typical for the stick to be made from a non-edible material having a flavor, if any, inherent to the material from which the stick is formed (i.e., the flavor of wood in the case of a wooden stick) that can be markedly different from the taste of the food product that is attached thereto.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is a food treat comprising: a stick comprising a first portion and a second portion and a flavored coating, an inner portion of the stick infused with the flavoring coating; and a food product attached to the first portion of the stick, the second portion of the stick exposed to an ambient environment.

In a further aspect, disclosed is a method for making a food treat on a stick, the method comprising: soaking a stick in a flavoring solution for a period of time, drying the stick either in ambient air or in air at an elevated temperature, and attaching a food product to the stick.

In a further aspect, disclosed is a food treat comprising: a stick comprising a first portion, a second portion, and a coating; the first portion of the stick infused with the coating; and a food product attached to the first portion of the stick, the second portion of the stick configured to be held by a user.

In a further aspect, disclosed is a coating system comprises: a container; a flavoring solution held by the container; and a stick submerged in the flavoring solution, the flavoring solution comprising a flavoring oil.

In a further aspect, disclosed is a method for making a food treat, the method comprising: placing a stick into a flavoring solution in a container, the stick comprising a first portion and a second portion; soaking the stick in the flavoring solution until the first portion is coated with the flavoring solution; removing the stick from the flavoring solution; and forming a food product around the first portion of the stick to form a food treat such that the second portion of the stick comprises a holding portion of the food treat.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the invention and together with the description, serve to explain various principles of the invention. The drawings are not necessarily drawn to scale. Corresponding features and components throughout the figures may be designated by matching reference characters for the sake of consistency and clarity.

FIG. 1 is a perspective view of a food treat in accordance with one aspect of the current disclosure.

FIG. 2 is a perspective view of the stick of the food treat of FIG. 1.

FIG. 3 is a sectional view of the stick of FIG. 2 taken along line 3-3 of FIG. 2.

FIG. 4 is a exploded perspective view of a system for coating sticks comprising a container in accordance with another aspect of the current disclosure.

FIG. 5 is a sectional view of the system of FIG. 4 as assembled.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the one aspect of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to a quantity of one of a particular element can include two or more such elements unless the context indicates otherwise.

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list.

In one aspect, a food treat having a flavored stick and associated methods, systems, devices, and various apparatuses are disclosed herein. In one aspect, the food treat can comprise a frozen food product on a stick such as, for example and without limitation, a popsicle. In another aspect, the food treat can comprise a non-frozen food product on a stick such as, for example and without limitation, a candied apple, or a hot food product such as, for example and without limitation, a corn dog.

For a person who consumes a food treat such as a popsicle comprising a frozen fruit bar attached to a wooden stick, the enjoyment experienced from eating the frozen fruit bar portion of the food treat can be significantly dampened when the one consuming the food treat bites into the plain wooden stick included therein. Flavoring the stick by coating and/or infusing the stick with a flavoring can result in an enjoyable eating experience from beginning to end by giving the stick itself a more attractive taste, either matching, complementing, or contrasting with the taste of the food product attached to the stick. Coating the stick means covering at least partly a surface of the stick with the flavoring, while infusing the stick means penetrating the surface of the stick with the flavoring such that the flavoring reaches an inner portion of the stick.

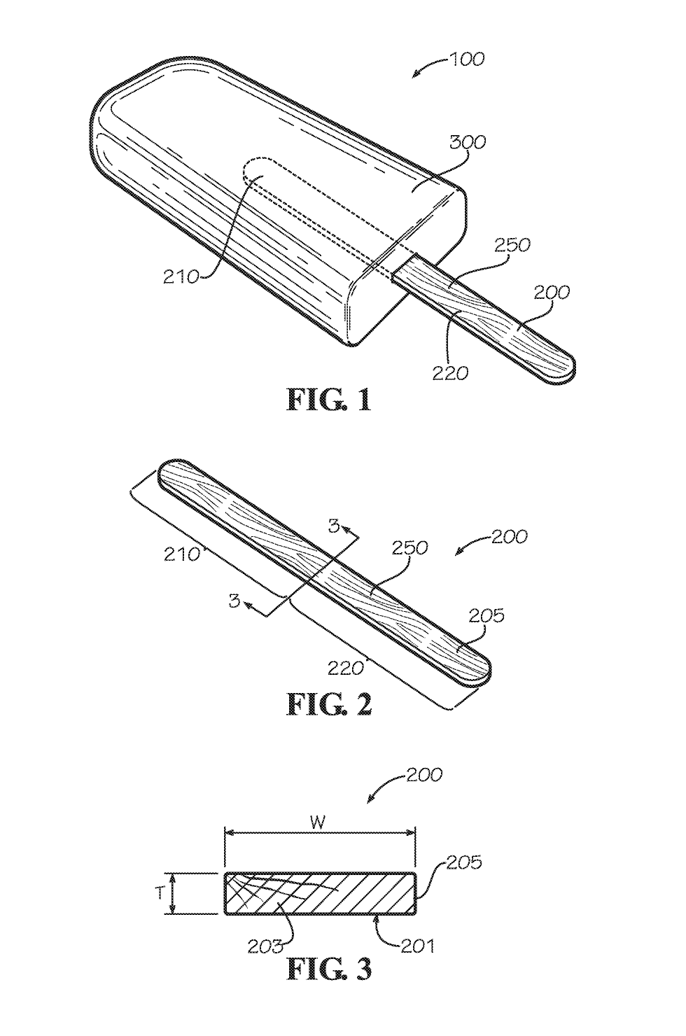

One embodiment of a food treat comprising a flavored stick is disclosed in FIG. 1. The food treat 100 comprises a stick 200 and a food product 300. The stick 200 comprises a first portion 210 and a second portion 220 and a coating 250. The first portion 210 of the stick 200 is that portion of the stick 200 to which the food product 300 is attached. The second portion 220 of the stick 200 is that portion of the stick 200 that is exposed to an ambient environment. The second portion 220 can comprise a holding portion configured to be held by a user. Having the second portion 220 of the stick 200 exposed to the ambient air environment can provide benefits during manufacturing and consuming of the food treat 100, some of which are described herein.

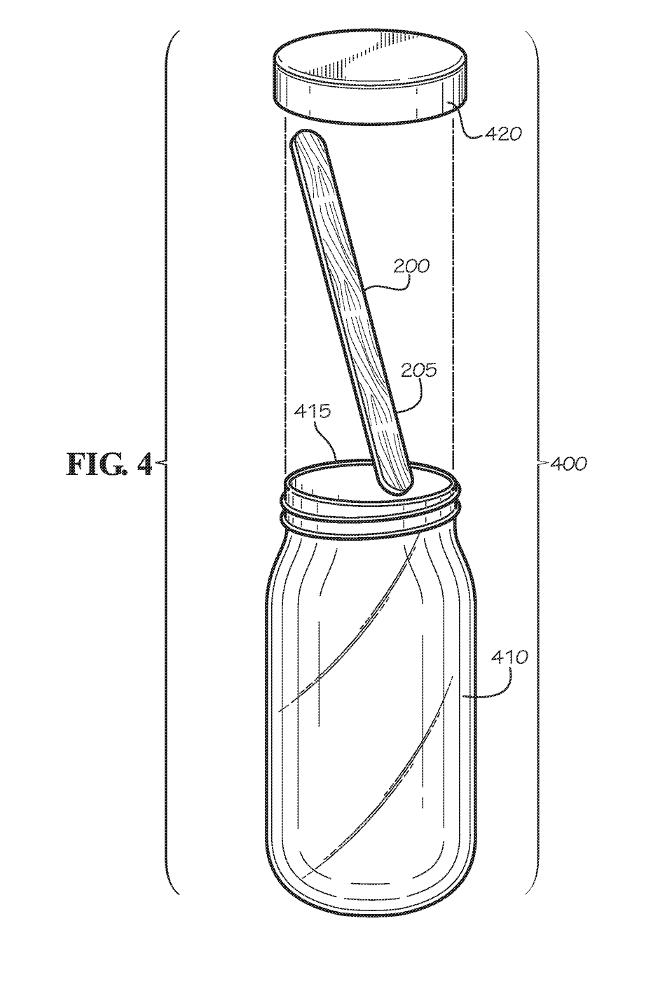

FIG. 2 discloses the stick 200 without the food product 300. In one aspect, the stick 200 is a traditional wooden popsicle stick and can be made out of a wood material such as, for example and without limitation, basswood. Basswood is a wood species having sufficient structural strength to support the weight of the food product 300 in various spatial orientations of the food treat 100, and yet is lightweight and soft so as to “give” when bitten into by human teeth, is non-toxic, and inexpensive. In another aspect, other wood species with similar non-toxic properties, however, can also be used, such as birch wood. In yet another aspect, a non-wood non-toxic material or even an edible material can be used to form the stick 200. To say that the stick 200 comprises wood or is made from wood or a wood material means that the stick 200 comprises a material or is made from a material that is wood or a wood by-product.

In one aspect, the food product 300 can be a frozen food product. For example and without limitation, the food product 300 can be a frozen fruit bar or a frozen chocolate bar. In another aspect, the food product 300 can be a non-frozen food product. For example and without limitation, the food product 300 can be a candied apple. In a further aspect, the food product 300 can be a hot food product. For example and without limitation, the food product 300 can be a corn dog.

In one aspect, the coating 250 comprises a flavoring used in making candy or otherwise used in baking food products. For example and without limitation, the flavoring can be a flavoring oil, such as a candy or baking flavoring oil produced by LorAnn Oils of Lansing, Mich. The flavoring oil can have, for example and without limitation, a fruit flavor, a vegetable flavor, a nut flavor, a beverage flavor, a candy flavor, a spice flavor, a coffee flavor, a natural oil flavor, or another food flavor. In another aspect, the flavoring can also be an extract, fruit juice, chocolate syrup, or a concentrate dissolved in a solution. The flavoring can be chosen to match, complement, or contrast positively with the flavor of the food treat attached to the stick 200. Further, the flavoring can comprise colorants, sweeteners, vitamins, minerals, or other ingredients.

In one aspect, the stick 200 and specifically the holding portion or the second portion 220 of the stick 200 is configured to be held in the hand of a user by forming the stick into a shape that can be held easily by a human hand. The shape of the stick 200 shown in FIG. 2 is the traditional shape of a popsicle stick. Due to the flat and wide shape of the stick 200, which has a body 205 with a rectangular cross-section defining a width W and a thickness T (both shown in FIG. 4), only a small amount of force is necessary to hold the stick 200. The width W is measured in a direction that is perpendicular to a longitudinal direction of the stick 200. In one aspect, the thickness T measures less than the width W. The thickness T can further measure substantially less than the width W such that the width W is at least four to five times the thickness T. In another aspect, the stick 200 can have a round shape in cross-section which can also be held easily. In yet another aspect, the stick can have another shape in cross-section including but not limited to any polygonal shape.

FIG. 3 discloses a sectional view of the stick 200. The body 205 of the stick 200 comprises an outer surface 201 and an inner portion 203. In one aspect, the stick 200 can be coated on only the outer surface 201 without the flavoring reaching the inner portion 203. In another aspect, the stick 200 is infused with the flavoring such that the flavoring reaches the inner portion 203 either throughout the inner portion 203 or to a desired depth into the inner portion 203. In one aspect, the thinner or less viscous the flavoring, generally the more the flavoring infuses the stick 200. In another aspect, the more porous the material used to form the stick 200, generally the more the flavoring infuses the stick 200. For example and without limitation, the stick 200 formed from the aforementioned basswood wood species will be sufficiently porous for infusion into the inner portion 203 by the flavoring. In one aspect, infusing the stick 200 beyond the outer surface 201 and into the inner portion 203 causes the person consuming the food treat 100 to be able to experience the flavor for a longer period of time.

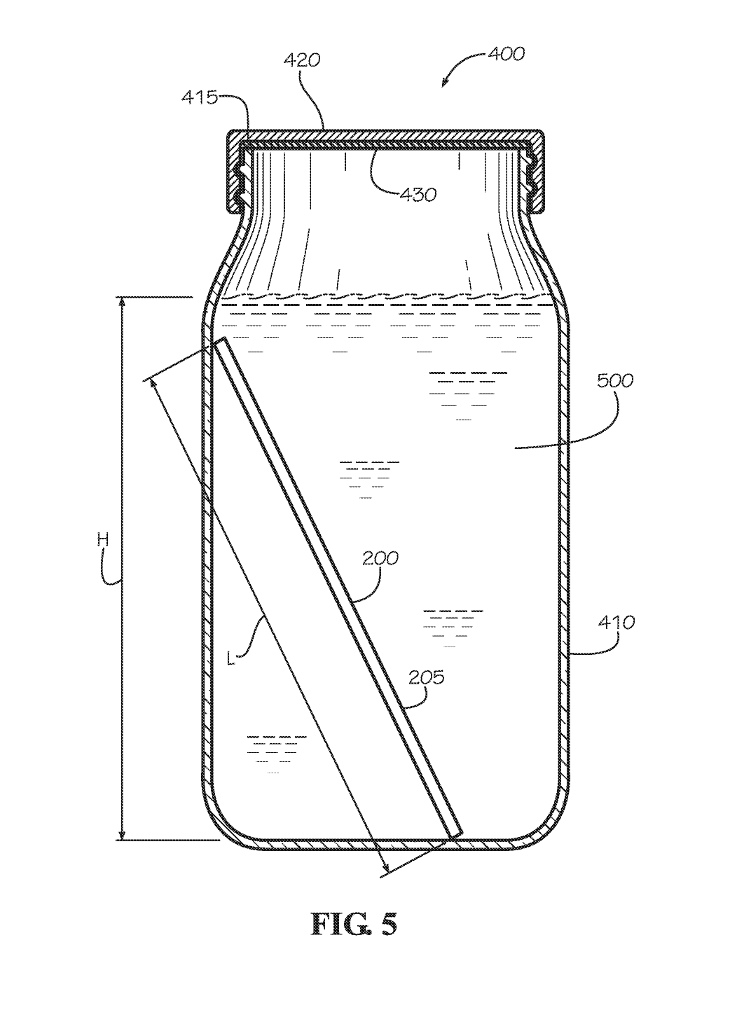

FIG. 4 discloses a flavoring system or a coating system 400 for coating and infusing either a single stick 200 or a plurality of sticks 200 with the coating 250. The coating system 400 can comprise a container 410, a container lid 420 comprising a container seal 430 (shown in FIG. 5), a stick 200, and a flavoring solution 500 (shown in FIG. 5), which can be a coating solution. The container 410 can be, for example and without limitation, a clear glass jar such as a Mason jar sized to receive a stick 200 inside and the container lid 420 at an opening 415 defined in a first end of the container 410, which can be a top end of the container 410.

In FIG. 5, the coating system 400, shown in cross-section, can be assembled with the container lid 420 sealed against the container 410 with the assistance of a container seal 430 sealed against the opening 415 of the container 410. The container 410 can be filled to a fill level H with the flavoring solution 500. In one aspect, as shown, the fill level H can be greater than a length L of the stick 200 to ensure that the stick 200 is contained or fully submerged within the flavoring solution 500. In another aspect, the fill level H is less than the length L of the stick 200, in which case the stick 200 can be only partially submerged and either just a portion of the stick 200 can be coated, such as just the first portion 210, or the coating system 400 can be shaken so that the flavoring solution 500 is made to cover the stick 200. In such aspect where the fill level H is less than the length L of the stick 200 and just a portion of the stick 200 is coated, an uncoated portion of the stick 200, such as the exposed second portion 220 of the stick 200, can be held without touching the coating 250.

In one exemplary aspect, a method for making the food treat 100 comprises soaking a stick 200 in the flavoring solution 500 for a period of time, drying the stick 200 either in ambient air or in air at an elevated temperature, and attaching the food product 300 to the stick 200.

In another exemplary aspect, a method for making a food treat 100 on a stick 200 comprises pouring the flavoring solution 500 into the container 410 having the opening 415 at the top end. The method can further comprise placing a single stick 200—or a plurality of sticks 200—into the container 410 through the opening 415. The method can further comprise assembling a container lid 420 to the container 410 to seal the opening 415. The method can further comprise shaking the container 410 to completely coat each of the sticks 200. The method can further comprise shaking the container 410 at least once more to keep the sticks 200 from sticking to each other. The method can further comprise leaving the sticks 200 in the container 410 for a specified period of time. The method can further comprise placing wax paper (not shown) on a flat horizontal surface (not shown). The method can further comprise placing the sticks 200 on an upper surface of the wax paper and spreading the sticks 200 out so that the sticks 200 are not touching each other.

In one aspect, after removing the sticks 200 from the container 410, the method can further comprise leaving the sticks 200 out in the ambient environment to air dry until the sticks 200 are no longer wet or sticky. Once each of the plurality of sticks 200 is no longer wet or sticky, the method can further comprise either placing each of the plurality of sticks 200 inside the food product 300 or forming the food product 300 around the stick 200, such as by placing the sticks 200 into flavored liquid and thereafter freezing the liquid around the sticks 200 to form popsicles.

In another aspect, after removing the sticks 200 from the container 410, the method can further comprise placing each of the plurality of sticks 200 on a cookie sheet (not shown) or any flat surface and baking the sticks at a specified temperature for a specified amount of time. In such aspect, the method can further comprise removing the sticks 200 immediately from the cookie sheet to prevent the sticks 200 from sticking to the cookie sheet. Once each of the plurality of sticks 200 is no longer wet or sticky, the method can further comprise placing each of the sticks inside a food product 300 or forming the food product 300 around the stick 200.

In another exemplary aspect, the method for coating the sticks 200 with the coating 250 can comprise pouring two 0.125 fluid ounce bottles of flavoring solution 500 in a container 410. The method can further comprise placing 25 sticks 200 inside the container 410 and assembling the container lid 420 to the container 410. The method can further comprise soaking the sticks 200 in the flavoring solution 500 until the first portion 210 is coated with the flavoring solution 500. The method can further comprise shaking the container 410 to completely coat each of the sticks 200. The method can further comprise shaking the container 410 every few hours, to keep the sticks 200 from sticking to each other. The method can further comprise leaving the sticks 200 in the container 410 for 24 hours. The method can further comprise placing a length of wax paper on a table, pouring the sticks 200 out on the wax paper and spreading the sticks 200 out so that the sticks 200 are not touching each other. The method can further comprise leaving the sticks 200 out to dry, which can take as long as 24 hours, or placing the sticks 200 on a cookie sheet and baking at 225 degrees Fahrenheit for five minutes to dry until the sticks 200 are no longer sticky to the touch. The method can further comprise removing the sticks 200 immediately from the cookie sheet after baking the sticks 200 to prevent the sticks 200 from sticking to the cookie sheet. The method can further comprise removing the sticks 200 from the flat surface after baking the sticks 200 and before the sticks 200 cool to ambient temperature. In another aspect, the method can comprise air drying the sticks 200 on any flat surface in ambient air. The method can comprise processing through any one of the above method steps as few as one stick 200 or any number of sticks 200, including more than 25 sticks 200.

To suit individual tastes, the amount or concentration of flavoring solution 500 can be increased or decreased to create flavored sticks 200 having a stronger or a weaker flavor.

In one aspect, the food treat 100 can be made at home. In another aspect, the food treat 100 can be made in a food processing facility with food processing equipment more advanced than that disclosed herein but familiar to one of ordinary skill in the art. In a further aspect, the stick 200 could be boiled or otherwise put in heated flavoring solution to help infuse flavor into the stick 200. In a further aspect, the stick 200 can be sprayed with flavoring to infuse flavor into the stick 200.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A food treat comprising:
a stick comprising a first portion, a second portion, and a flavoring; the first portion of the stick coated with the flavoring; and
a food product attached to the first portion of the stick, the second portion of the stick configured to be held by a user.

2. The food treat of claim 1, wherein the stick comprises wood.

3. The food treat of claim 2, wherein the stick comprises basswood or birch.

4. The food treat of claim 1, wherein the first portion of the stick is infused with the flavoring into an inner portion of the stick.

5. The food treat of claim 1, wherein the stick has a rectangular cross-section defining a width and a thickness, the width measured in a direction that is perpendicular to a longitudinal direction of the stick and the thickness measuring less than the width.

6. The food treat of claim 1, wherein the second portion of the stick is infused with the flavoring.

7. The food treat of claim 1, wherein the flavoring comprises a flavoring oil.

8. The food treat of claim 1, wherein the flavoring comprises an extract, a fruit juice, a concentrate dissolved in a solution, or a chocolate syrup.

9. The food treat of claim 1, wherein the food product is a frozen food product.

10. A coating system comprising:
a container;
a flavoring solution held by the container; and
a stick submerged in the flavoring solution, the flavoring solution comprising a flavoring oil.

11. The system of claim 10, wherein the container is a jar defining an opening.

12. The system of claim 10, further comprising a container lid, the container lid comprising a container seal.

13. The system of claim 10, wherein the stick is partially submerged in the flavoring solution.

14. A method for making a food treat, the method comprising:
placing a stick into a flavoring solution in a container, the stick comprising a first portion and a second portion;
soaking the stick in the flavoring solution until the first portion is coated with the flavoring solution;
removing the stick from the flavoring solution; and
forming a food product around the first portion of the stick to form a food treat such that the second portion of the stick comprises a holding portion of the food treat.

15. The method of claim 14, further comprising placing the stick on a flat surface and baking the stick at 225 degrees Fahrenheit for at least five minutes.

16. The method of claim 15, further comprising removing the stick from the flat surface after baking the stick and before the stick cools to ambient temperature.

17. The method of claim 14, further comprising air drying the stick in ambient air.

18. The method of claim 14, further comprising shaking the container to completely coat the stick.

19. The method of claim 14, further comprising leaving the stick in the container for 24 hours.

20. The method of claim 14, further comprising placing a second stick into the flavoring solution with the first stick.
